(19) United States
(12) Patent Application Publication
(10) Pub. No.: US 2025/0321095 A1
(43) Pub. Date: Oct. 16, 2025

(54) MEASURING DEVICE

(71) Applicant: MITUTOYO CORPORATION, Kanagawa (JP)

(72) Inventors: Kinya INOUE, Kanagawa (JP); Katsutoshi IKEZAKI, Kanagawa (JP)

(73) Assignee: MITUTOYO CORPORATION, Kanagawa (JP)

(21) Appl. No.: 19/175,253

(22) Filed: Apr. 10, 2025

(30) Foreign Application Priority Data
Apr. 12, 2024 (JP) 2024-064758

(51) Int. Cl. G01B 21/04

(52) U.S. Cl. CPC G01B 21/042; G01B 21/047

(57) ABSTRACT

There is provided a measuring device capable of improving measurement accuracy by eliminating influences of user operations in setting a base point and in finalizing measurement data. An operation reception unit of a measuring device receives a measurement data finalization command to finalize measurement data. A central control unit sequentially stores measurement values in a memory as tentatively finalized measurement data when a proximity sensor detects that a finger has approached the operation reception unit. The central control unit determines one or two or more pieces in the tentatively finalized measurement data stored in the memory as finalized measurement data when the operation reception unit receives the measurement data finalization command.

### INCORPORATION BY REFERENCE

This application is based upon and claims the benefit of priority from JP patent application No. 2024-064758, filed on Apr. 12, 2024 (DAS code 5A19), the disclosure of which is incorporated herein in its entirety by reference.

### BACKGROUND OF THE INVENTION

### 1. Field of the Invention

The present invention relates to a small-sized measuring device.

### 2. Description of Related Art

Calipers, micrometers, dial gauges (indicators), lever-type dial gauges (test indicators), height gauges, and the like are widely used as small-sized measuring devices (small tools) to measure the dimensions and the like of objects to be measured.
Patent Literature 1: JP 6472309 B
Patent Literature 2: JP 5192144 B

### SUMMARY OF THE INVENTION

In the cases of using a dial gauge or a lever-type dial gauge, the base point (origin) is often set while its contact point is in contact with a workpiece, a master workpiece, or a gauge block. At this time, a user sets and captures the base point (origin) by operating buttons. However, when the user operates a button, that is, the user presses a measuring device, the position and posture of the measuring device are changed. Then, the base point (origin) is shifted, which causes errors in measurement values even in subsequent measurement operations when a command is input by button operation.

A purpose of the present invention is to provide a measuring device capable of improving measurement accuracy by eliminating influences of user operations in setting a base point (origin) and in finalizing measurement data.

A measuring device according to an exemplary embodiment of the present invention includes:
a main body;
a position detector provided on the main body and configured to detect a position of an object to be measured by contact or non-contact;
an operation reception unit provided on the main body and configured to receive a command/operation from a user;
a proximity sensor configured to measure a distance between an object and the operation reception unit when the object approaches or moves away from the operation reception unit; and
a central control unit configured to control an overall operation.

A control method of a measuring device according to an exemplary embodiment of the present invention, the measuring device including a position detector provided on a main body and configured to detect a position of an object to be measured by contact or non-contact, an operation reception unit provided on the main body and configured to receive an command/operation from a user, a proximity sensor configured to measure a distance between an object and the operation reception unit when the object approaches or moves away from the operation reception unit, and a central control unit configured to control an overall operation, the control method includes:
sequentially storing, by the central control unit, measurement values from the position detector in a memory unit as tentatively finalized measurement data when the proximity sensor detects that the object has approached the operation reception unit; and
determining, by the central control unit, one or two or more pieces in the tentatively finalized measurement data stored in the memory unit as finalized measurement data when the operation reception unit receives a measurement data finalization command.

### BRIEF DESCRIPTION OF THE DRAWINGS

FIG. 1 is an external view of an indicator;

FIG. 2 is a diagram showing an example of the use of the indicator attached to a stand;

FIG. 3 is a functional block diagram showing an electric circuit;

FIG. 4 is a flowchart for explaining the operation of the indicator during button operation;

FIG. 5 is a flowchart for explaining the operation of the indicator during button operation;

FIG. 6 is a flowchart for explaining a base point setting operation;

FIG. 7 is a flowchart for explaining a hold mode switch operation;

FIG. 8 is a flowchart for explaining a data finalization operation;

FIG. 9 is a timing chart during the base point setting operation;

FIG. 10 is a timing chart during the hold mode switch operation; and

FIG. 11 is a timing chart during the data finalization operation.

### DETAILED DESCRIPTION

Embodiments of the present invention are illustrated and described with reference to the reference signs assigned to the elements in the drawings.

Note that, individual embodiments, examples, and modifications may be implemented independently, or two or more embodiments, examples, and modifications may be implemented in combination, and examples of modifications supplemented by individual embodiments, examples, and modifications are applicable to other embodiments, examples, and modifications.

### First Exemplary Embodiment

A first exemplary embodiment of the present invention is described below.

A small-sized measuring device in the present exemplary embodiment is a portable small-sized measuring device that can be carried in a user's hand and is intended to be used while attached to a stand to maintain a relative posture or a relative position with respect to an object to be measured. The small-sized measuring device is intended to be used for micro-displacement measurements, such as surface textures, contours, dimensions (for example, height and width by comparative length measurement), circular runout, total runout, flatness, parallelism, and the like of the object to be measured and machining errors of machined products relative to a master workpiece (or block gauge). Such measuring devices include, for example, dial gauges and lever-type dial gauges. (This type of measuring device is also called an indicator, test indicator, digital indicator, digital test indicator, linear gauge, height gauge, and the like.)

In the present exemplary embodiment, what is called a digital indicator 100 (hereinafter, referred to as an “indicator”) is described as an example.

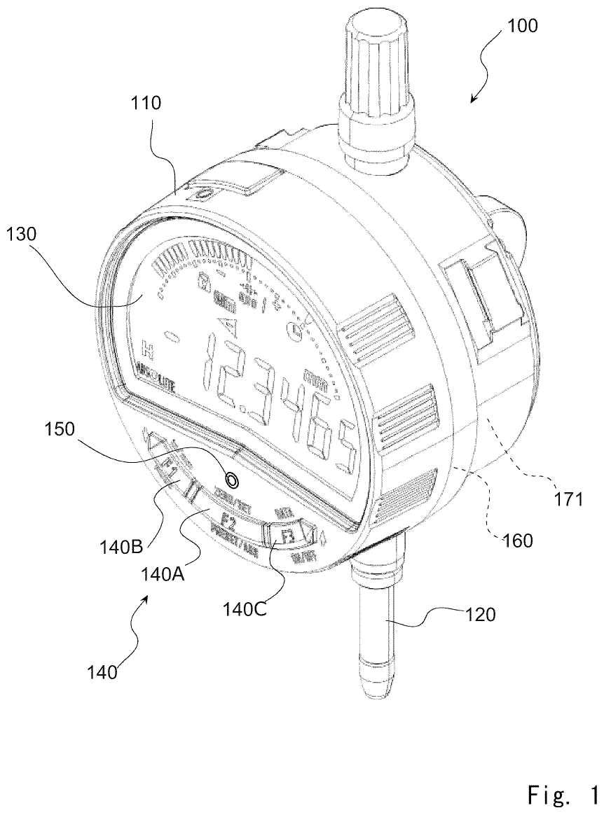

FIG. 1 is an external view of the indicator 100.

The indicator 100 digitally displays the displacement of a spindle 120 on a display unit 130. The indicator 100 includes a measuring device main body 110, a spindle (movable member) 120, a display unit 130, a plurality of operation buttons (operation reception unit) 140, a proximity sensor 150, an inertial sensor 160, and an electric circuit 170.

The measuring device main body 110 is a short cylindrical case body.

The spindle 120 includes a contact point at its tip and is supported so as to be movable forward and backward through the measuring device main body 110 in the axis direction. The measuring device main body 110 incorporates an encoder 171 that detects the displacement of the spindle 120. The encoder 171 is a sensor that outputs an electrical signal according to the displacement (or absolute position) of the object to be measured and is, for example, a linear encoder or a rotary encoder. The detection principles of the encoder include photoelectric, capacitive, electromagnetic induction, and magnetic, and the detection methods include incremental and absolute.

In this example, the spindle 120 and the encoder 171 constitute a position detector that detects the position (or displacement) of the object to be measured.

The display unit 130 is disposed in an approximately central region on the front side end face of the measuring device main body 110. The display unit 130 is, for example, a liquid crystal display panel. The display unit 130 may be a segment or dot matrix liquid crystal display panel, an organic EL panel, or an electronic paper.

The display unit 130 has a numerical display field and an analog scale display field. The numerical display field shows numerical values. The meaning of the numerical values shown here depends on the mode selected at the time. For example, in a measurement mode, the numeric value in the numerical display field is a measurement value itself. The measurement value is expressed, for example, as the difference from the base point (origin) set by calibration.

In a hold mode, the measurement value (displayed value) is fixed and displayed. For example, depending on the user setting, the maximum value (Max) or the minimum value (Min) can be displayed on hold. Alternatively, the middle value between the maximum and minimum values (here, referred to as the intermediate value) may be displayed on hold (intermediate-value hold display). Furthermore, the runout range (maximum value-minimum value, Tir) in a runout measurement may be displayed on hold.

In a tolerance setting mode or a preset mode, the numerical value in the numerical display field indicates the tolerance or preset value entered by the user through an input means (operation buttons).

The analog scale display field shows an arc-shaped scale and several marks that are displayed and controlled in conjunction with the scale. On the arc-shaped scale, marks imitating a pointer meter are displayed so as to light up, move, or increase/decrease according to the measurement value (displayed value). In addition, a mark indicating the maximum tolerance, which is the upper limit value, and a mark indicating the minimum tolerance, which is the lower limit value, may also be displayed in conjunction with the arc-shaped scale.

As the input means (operation reception unit 140), a plurality of operation buttons (operation reception units 140) is provided. The operation buttons 140 are disposed below the display unit 130 on the front side end face of the measuring device main body 110. These operation buttons 140 are assigned functions such as a mode switching command and a numerical value capturing command. In the present exemplary embodiment, a base point setting button 140A, a hold mode switching button 140B, and a data finalizing button 140C are provided as the input means (the operation reception units 140).

The operation buttons (the operation reception units) 140 may be mechanical push buttons or, for example, “buttons” displayed on a touch panel. (The detection method of the touch panel may be pressure-sensitive, capacitive, electromagnetic induction, or any other method.)

The proximity sensor 150 is disposed between the display unit 130 and the input means (the operation reception units 140) on the front side end face of the measuring device main body 110. The proximity sensor 150 is preferably disposed as close as possible to the input means (the operation reception units 140). For example, the distance between the input means (the operation reception units 140) and the proximity sensor 150 is 10 mm or less, preferably 5 mm or less, more preferably 2 mm or less in plan view, and the proximity sensor 150 may be in contact with the buttons or on the buttons. In the present exemplary embodiment, the proximity sensor 150 is an optical proximity sensor (proximity light sensor), which is a so-called short-range optical distance measurement sensor that emits light and measures the distance to an object based on the detection time of the reflected light, such as a TOF sensor and LiDER.

However, the detection method of the proximity sensor is not particularly limited. For example, a capacitive proximity sensor or an electromagnetic induction proximity sensor may be used.

Alternatively, a camera may be used as the proximity sensor 150. For example, a small-sized camera may be disposed next to the operation buttons (the operation reception units 140). As a finger gradually approaches the operation buttons, that is, the finger gradually approaches the camera, the area of the finger in the imaging visual field of the camera gradually increases. Therefore, the distance between the operation buttons and the finger can be measured from the size of the finger in the visual field of the camera.

Since a finger is a typical example of an object that operates the operation reception units 140, a finger will be continuously used in the following description as an object that operates the operation reception units 140.s

The proximity sensor 150 may recognize that an object approaching or moving away is a finger (human body), and then measure the distance to the finger (human body). The proximity sensor 150 may recognize whether an approaching object is a finger (human body) or an object other than a finger (human body) using a separate camera or the like, and then measure the distance to the finger (human body). Alternatively, the proximity sensor 150 may determine whether an approaching object is a finger (human body) or an object other than a finger (human body) based on the reflectance or wavelength of light from the finger (human body), and other factors such as capacitance.

Alternatively, the proximity sensor 150 may measure the distance to an object approaching or moving away from the measuring device (operation reception units 140), regardless of whether the object approaching or moving away is a finger (human body) or not. In the first place, an object that comes extremely close to the operation buttons 140 of the measuring device is likely to be a finger to operate the buttons. Therefore, anything that comes closer to the operation buttons 140 than a predetermined approach determination threshold is considered to be a finger and is measured.

The indicator (measuring device) 100 in the present exemplary embodiment includes the single proximity sensor 150 for the three operation reception units 140 (the base point setting button 140A, the hold mode switching button 140B, and the data finalizing button 140C), and the single proximity sensor 150 is common to the three operation reception units 140.

The proximity sensors 150 may be provided for each of the three operation reception units 140 (the base point setting button 140A, the hold mode switching button 140B, and the data finalizing button 140C).

This means that a proximity sensor for the base point setting button is provided to measure the distance of an object (finger) approaching and moving away from the base point setting button 140A, a proximity sensor for the hold mode switching button is provided to measure the distance of an object (finger) approaching or moving away from the hold mode switching button 140B, and a proximity sensor for the data finalizing button is provided to measure the distance of an object (finger) approaching or moving away from the data finalizing button 140C. Each proximity sensor can be disposed in various ways, including very proximal to each operation button, substantially adjacent to each operation button, or embedded in the key top of each operation button.

However, it is not easy to embed multiple proximity sensors in a small-sized compact measuring device and monitor their sensor values. In addition, when a finger approaches the multiple (three) operation buttons disposed side by side, it is difficult to reliably predict which operation button will eventually be pressed based on the proximity of the finger and the approach trajectory. Therefore, it is reasonable to provide a single proximity sensor to be shared by the multiple (three) operation buttons that are disposed collectively.

The proximity sensor is only required to detect the proximity between a finger (an object that operates the operation reception units) and the operation reception units, and the position of the proximity sensor is not limited. The proximity sensor may be disposed inside or on the outer surface of the measuring device main body, not only on the front side end face, but also on the side or back face. In the present exemplary embodiment, the proximity sensor is disposed on the measuring device main body, but the proximity sensor may be disposed separately from the measuring device main body. For example, a camera that can capture images of the area around the measuring device in its visual field may capture the finger and the measuring device to detect the distance (proximity) between the finger and the measuring device (the operation reception units). A sensor (proximity sensor) may be attached to a finger, hand or wrist of a user to detect the distance (proximity) between the finger and the measuring device (operation reception units).

The inertial sensor 160 is disposed on the measuring device main body 110. Here, it is assumed that the inertial sensor 160 is disposed inside the measuring device main body 110, but may be attached to the outer surface of the measuring device main body 110, or may be optionally detachable (attached or inserted into a slot) later. The inertial sensor 160 is known and is, for example, a 6-axis inertial sensor 160 (3-axis gyro sensor+3-axis acceleration sensor) integrated on a single chip.

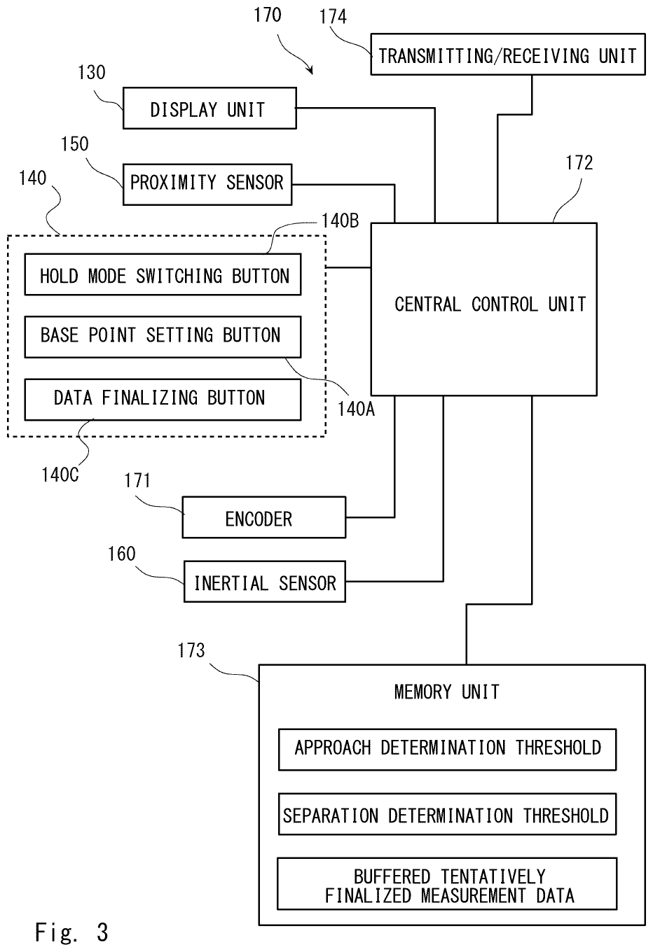

FIG. 3 is a functional block diagram showing the electric circuit 170.

The electric circuit 170 includes a central control unit 172 that controls the overall operation, a memory unit 173 that stores various set values or measurement values, and a transmitting/receiving unit 174 as a communicator to input and output data to and from external devices.

The central control unit 172 includes a counter that measures (or counts) the position (or displacement) of the spindle 120 based on a detection signal from the encoder 171. The central control unit 172 displays the value of the counter and the like on the display unit 130. The specific functions of the central control unit 172 and its control operations are described later.

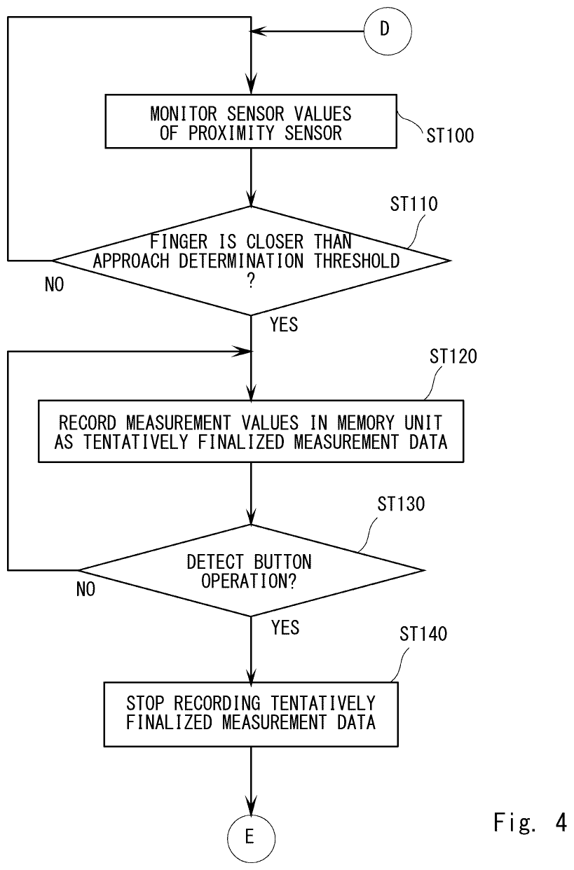

The operation of the indicator 100 in the present exemplary embodiment is described with reference to the flowcharts in FIGS. 4 to 8.

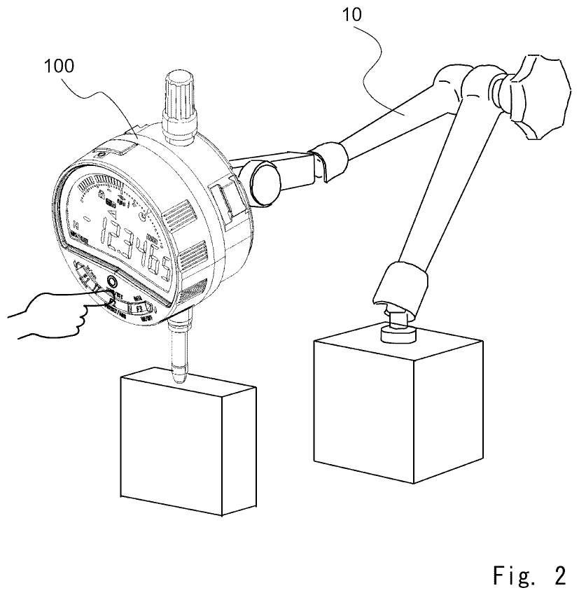

In measuring the shape or dimensions of a workpiece, a user attaches the indicator 100 to a stand 10 and installs the indicator 100 and a workpiece (object to be measured) W, as shown in FIG. 2, for example.

Here, when attaching the indicator 100 to the stand 10, the user attaches the indicator 100 to the stand 10 so that the spindle 120 of the indicator 100 is parallel to the vertical line, in order for the spindle 120 to approach the workpiece W from directly above along the vertical line. Thereafter, the user will press the operation buttons 140 on the indicator 100 as an operation during measurement. Therefore, it is important to firmly fix (screw-tighten) the joints between the indicator 100 and the stand 10 and the articulated parts of the stand 10 so that the posture and position of the indicator 100 will not change even when the operation buttons 140 of the indicator 100 are pressed. However, it is inevitable that the indicator 100 will vary slightly in its posture when a finger is brought into contact with the indicator 100 (the operation buttons 140) to input commands.

Once the indicator 100 is installed as shown in FIG. 2, the central control unit 172 acquires a count value of the encoder 171 and displays it temporarily as a measurement value on the display unit 130. While the power is on, the central control unit 172 acquires count values of the encoder 171 at a predetermined sampling pitch (for example, 20 ms to 50 ms pitch, 1 kHz to 2.5 kHz). If the spindle 120 is displaced, the value displayed on the display unit 130 will vary accordingly, but these temporary measurement values are not stored in a memory device, but disappear.

While the power is on, the central control unit 172 further monitors sensor values of the proximity sensor 150 (ST100). In other words, the indicator 100 monitors whether a finger is approaching the operation buttons 140.

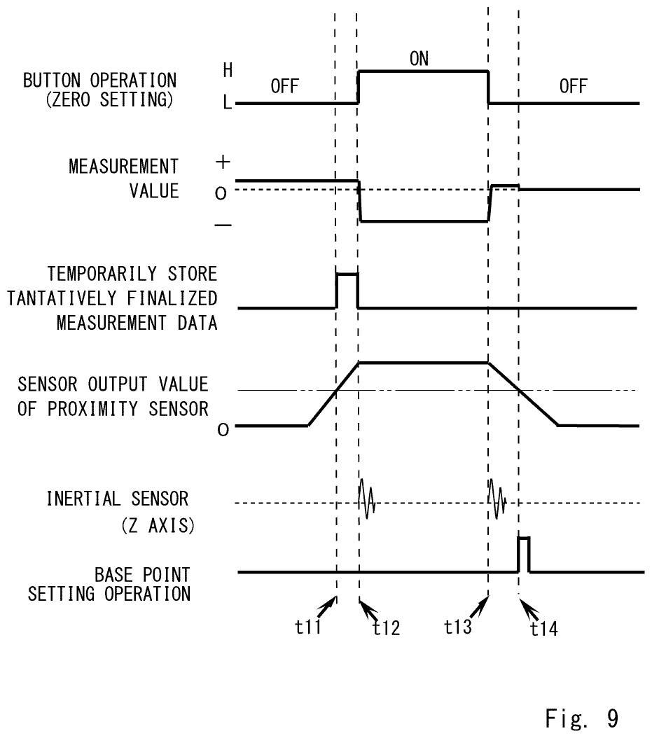

A determination threshold is set in the central control unit 172 or the memory unit 173 to determine the approach (proximity) or separation of a finger. Here, as shown in FIG. 9, a value of ½ of the maximum sensor output value of the proximity sensor 150 is set as the determination threshold. In the present exemplary embodiment, an approach determination threshold for determining the approach of a finger and a separation determination threshold for determining the separation of a finger are set to the same value, but they may be different. For example, the approach determination threshold for determining the approach of a finger may be ¾ of the maximum sensor output value of the proximity sensor 150, and the separation determination threshold for determining the separation of a finger may be ¼ of the maximum sensor output value of the proximity sensor 150. When the sensor value of the proximity sensor 150 exceeds the approach determination threshold, the finger is determined to be approaching the operation buttons 140. When the sensor value of the proximity sensor 150 falls below the separation determination threshold, the finger is determined to be away from the operation buttons 140.

Since the sensor value of the proximity sensor 150 is correlated (for example, inversely proportional) to the distance between the finger and the operation buttons 140, setting a determination threshold for the sensor value of the proximity sensor 150 is synonymous with setting a determination threshold for the distance between the finger and the operation buttons 140.

The first thing the user needs to do is to set the base point (set zero, calibrate the origin). Therefore, the user installs a master workpiece or a calibration gauge (for example, a block gauge), and presses the base point setting button 140A. Referring to FIG. 9, it is assumed that the temporary measurement value when the master workpiece is placed is slightly greater than zero. FIG. 9 is a timing chart during a base point setting operation.

The finger of the user gradually approaches the base point setting button 140A in order to press the base point setting button 140A. Then, the sensor output value of the proximity sensor 150 gradually increases and exceeds the approach determination threshold (time t11 in FIG. 9). At this time, the central control unit 172 determines that the finger is closer to the operation buttons 140 than the approach determination threshold (ST110: YES).

When the finger is approaching the operation buttons 140 (ST110: YES), the central control unit 172 transmits the counter values of the encoder 171 to the memory unit 173 and records them as tentatively finalized measurement data (ST120). In other words, the central control unit 172 buffers measurement data before the finger of the user touches the indicator 100 (operation buttons 140) (ST120). The tentatively finalized measurement data is sampled at a predetermined sampling pitch (for example, 20 ms to 50 ms pitch, 1 kHz to 2.5 kHz).

When the finger of the user presses the operation button 140 corresponding to a desired command, the central control unit 172 detects the button operation (ST130: YES) (time t12 in FIG. 9). Once the button operation is detected (ST130: YES), the central control unit 172 stops recording the tentatively finalized measurement data at this point (ST140).

These steps (ST120, ST140) are not related to the base point setting, but are necessary for a measurement data finalization operation, which will be described later. In the present exemplary embodiment, the single proximity sensor 150 is shared by the multiple (three) operation buttons (the base point setting button 140A, the hold mode switching button 140B, and the data finalizing button 140C), and these steps (ST120, ST140) are performed each time a finger approaches one of the operation buttons. In a case in which proximity sensors are disposed for the respective multiple (three) operation reception units 140 (the base point setting button 140A, the hold mode switching button 140B, and the data finalizing button 140C), ST120 and ST140 may be performed only when the proximity sensor for the data finalizing button detects an approach of a finger.

It is assumed that the base point setting button 140A is pressed as the button operation (ST150: YES). When the operation button 140 (the base point setting button 140A) is pressed, the indicator 100 varies in its posture, albeit very slightly. In FIG. 9, when the operation button 140 (the base point setting button 140A) is pressed, the measurement value slightly decreases due to the slight inclination of the indicator 100, or the like.

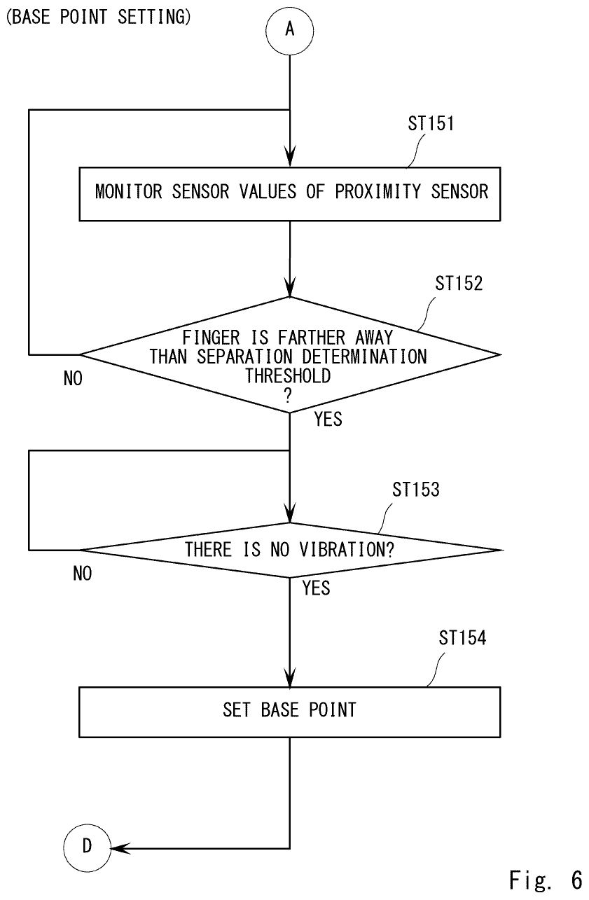

The operation when the button operation of the user is for a base point setting command (ST150: YES) is described continuously with reference to the flowchart in FIG. 6.

Even when the button operation of the user is detected to be the base point setting, the base point (origin) is not immediately set at this point (time t12). The central control unit 172 monitors the sensor output value of the proximity sensor 150 (ST151) and waits until the finger is completely separated away from the indicator 100 (the operation button 140).

When the finger is separated away from the base point setting button 140A at time t13 in FIG. 9, the central control unit 172 detects that the button operation is off. However, when the finger is separated away from the indicator 100 (the operation button 140) and then the sensor output value of the proximity sensor 150 falls below the separation determination threshold (ST152: YES), the central control unit 172 determines that the finger has been completely separated away from the indicator 100 (the operation button 140) (time t14 in FIG. 9).

In FIG. 9, when the finger is separated away from the base point setting button 140A at time t13, the indicator 100 returns to its original posture because the finger pressure is no longer applied, but the posture is not exactly the same as the original posture. In addition, when the finger is separated away from the base point setting button 140A at time t13, the indicator 100 varies to return to its original posture, which causes the indicator 100 to vibrate and the measurement value to vary slightly.

In the present exemplary embodiment, the sensor output value of the inertial sensor 160 is observed to confirm that there is no vibration (vibration is below a predetermined threshold) (ST153: YES). Then, the measurement value at this point (time t14 in FIG. 9) is set as the base point (origin) (ST154). In other words, the counter value of the encoder 171 is reset to zero at this point (time t14 in FIG. 9). (Alternatively, the measurement value at this point may be offset calibrated to be zero.) The display on the display unit 130 becomes zero at this moment. Now that the base point has been set, the operation procedure returns to the beginning (ST100 in FIG. 4).

In a conventional technique, the measurement value at time t12, at time t13, or after a predetermined delay time from time t13 is set as the base point (origin). However, at time t12 or time t13, the effect of the finger pressing the indicator 100 is reflected in the measurement value, which causes an error in the subsequent measurement values. Alternatively, even if the measurement value after a predetermined delay time from the time t13 is set as the base point (origin), the finger can be continuously in contact with the operation button 140 although the finger pressure is released and the determination of the operation button 140 is off. Conversely, even though the finger has been completely separated away from the operation button 140, there can be an extra waiting time before the base point is set.

In contrast, since the proximity sensor 150 is provided in the present exemplary embodiment, it is possible to set the base point (origin) at the very appropriate timing (time t14 in FIG. 9) when it is confirmed that the finger has been completely separated away from the operation button 140.

Note that the inertial sensor 160 detects vibration (acceleration) during the operation when the operation button 140 (in this case, the base point setting button 140A) is pressed.

Although FIG. 9 shows an example of acceleration occurring in the direction of the Z-axis (vertical axis in this case), the inertial sensor 160 may detect all the six axes. Then, the inertial sensor 160 may determine whether the detected acceleration (angular velocity) is greater than a predetermined threshold value, and notify the user with an alarm when the vibration is greater than the predetermined threshold value.

In addition, the inertial sensor 160 may measure the time between when the vibration exceeds the predetermined threshold and when the vibration falls below the predetermined threshold, and notify the user with an alarm when the vibration duration is too long.

Such an alarm informs the user that the indicator 100 can be loosely fixed, and allows the user to retighten the joints and articulated parts of the stand 10 securely.

Since the indicator 100 including the spindle 120 that moves forward and backward in the Z direction is used as an example in the present exemplary embodiment, the acceleration in the Z axis direction is focused on to determine whether the indicator (measuring device) 100 is properly fixed by determining whether the acceleration in the Z axis direction is at a predetermined threshold value.

In this case, the threshold for acceleration in the Z-axis direction (that is, the direction of the measurement axis) may be set more severely (strictly) than the thresholds in other directions.

In addition, the inertial sensor 160 may measure the installation orientation or inclination angle of the indicator 100, and notify the user with an alarm when the inclination is too great.

After the base point is set in this manner, the user measures the shape and dimensions of the actual workpiece. Therefore, the user performs a changeover to replace the workpiece to be measured.

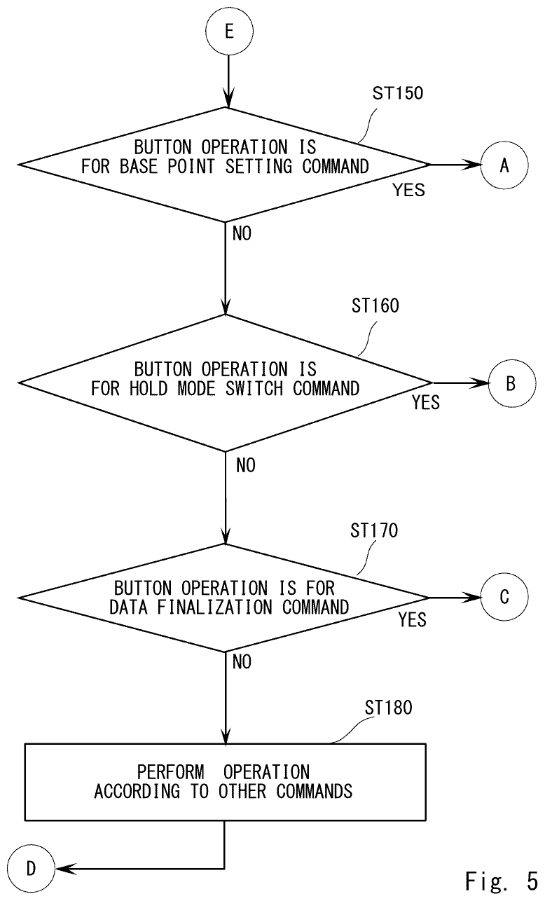

Returning to the flowcharts in FIGS. 4 and 5, the case in which the operation button 140 pressed by the user is the hold mode switching button 140B is described.

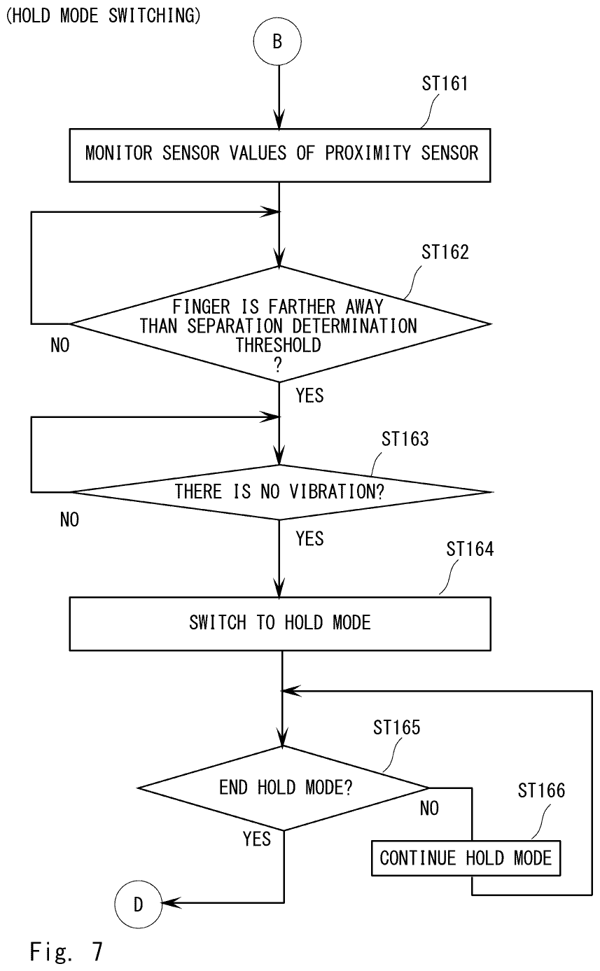

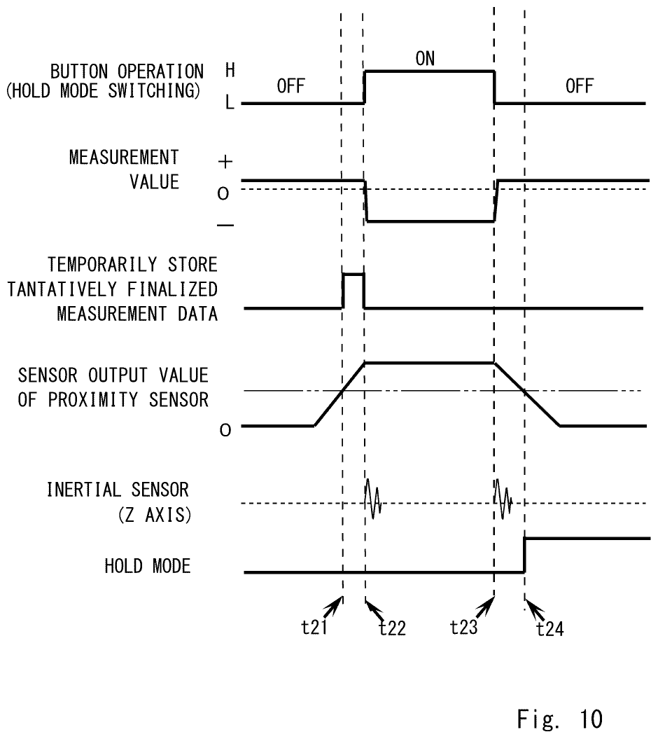

It is assumed that the procedure returns to the beginning of the flowchart in FIG. 4 (ST100), that a button operation is detected (ST130: YES), and that the button operation is for a hold mode switch command (ST160: YES). The operation procedure during the switch to the hold mode is shown in FIG. 7, and the timing chart is shown in FIG. 10.

The explanation of the timing of the switch to the hold mode is almost the same as the explanation of the base point setting.

In short, the central control unit 172 does not immediately execute the hold mode even when detecting the hold mode switching button 140B is pressed, but the central control unit 172 confirms that the sensor output value of the proximity sensor 150 falls below the separation determination threshold (ST162: YES) and that there is no vibration (ST163: YES), and then switches to the hold mode (t24 in FIG. 10).

In the hold mode, the maximum value (Max) or minimum value (Min) is displayed on hold. However, according to the present exemplary embodiment, it is possible to completely exclude the influence of the posture variation of the indicator 100 due to a button operation, and the maximum value (minimum value) displayed in the hold mode is not the magnitude of the posture variation of the indicator 100 or the like, but is an accurate reflection of the magnitude of the variation in the measurement value of an object to be measured.

Note that FIG. 10 shows that the posture of indicator 100 returns almost to the original posture after the button operation (t23 in FIG. 10) and that the measurement values also returns almost to the original value. FIG. 9 shows that the indicator 100 does not return to its original posture before and after the button operation, and therefore the measurement value also does not return. Since the button operation for setting the base point is the first button operation after the indicator (measuring device) 100 is installed on the stand, the backlash and gap of the fixtures (screws and the like) affect the indicator 100, but it is considered that the backlash and gap of the fixtures (screws and the like) are eliminated in the second and subsequent button operations, and the indicator 100 easily returns to its original position.

Returning to the flowcharts in FIGS. 4 and 5, the case in which the operation button 140 pressed by the user is the data finalizing button 140C is described.

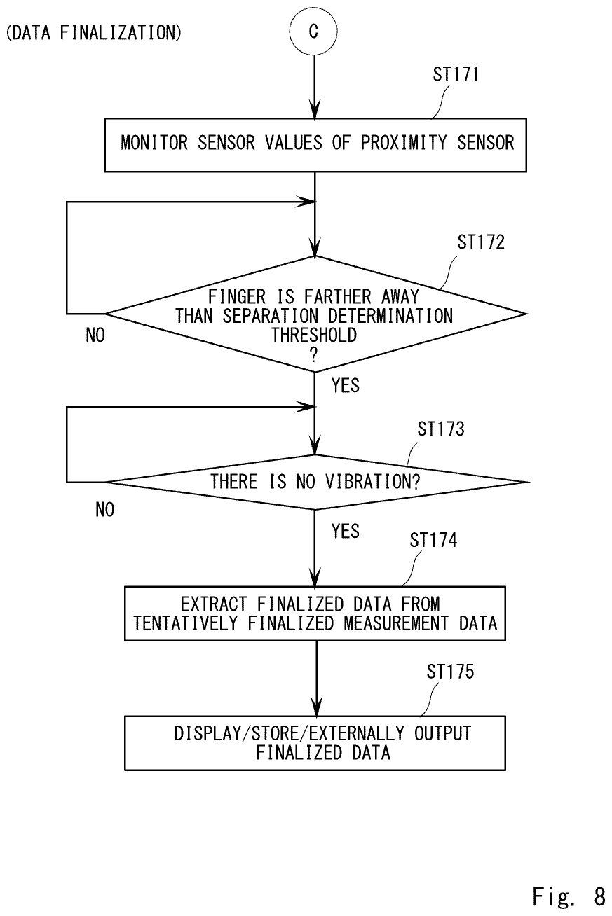

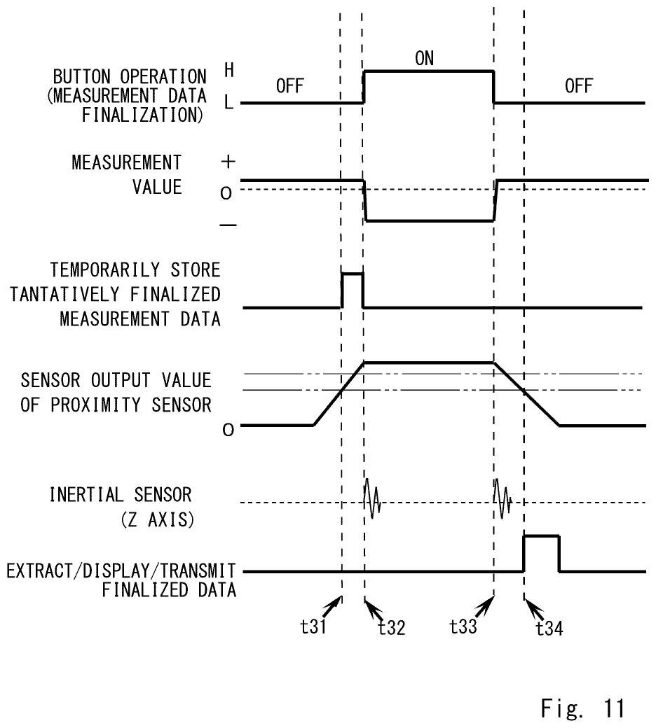

It is assumed that the procedure returns to the beginning of the flowchart in FIG. 4 (ST100), that a button operation is detected (ST130: YES), and that the button operation is for a measurement data finalization command (ST170: YES). The operation procedure in the case of measurement data finalization is shown in FIG. 8, and the timing chart is shown in FIG. 11.

As described above, when the finger of the user approaches the operation button 140 (the data finalizing button 140C) beyond the approach determination threshold in order to press the operation button 140 (the data finalizing button 140C) (ST110: YES), the central control unit 172 samples the counter values of the encoder 171 and records them as tentatively finalized measurement data. The central control unit 172 monitors the sensor values of the proximity sensor 150 (ST171), and when confirming that the sensor output value of the proximity sensor 150 falls below the separation determination threshold (ST172: YES) and further confirming that there is no vibration (ST173: YES), the central control unit 172 extracts finalized data from the tentatively finalized measurement data buffered in the memory unit 173 (ST174) (t34 in FIG. 11).

In extracting the finalized data from the tentatively finalized measurement data buffered in the memory unit 173, the tentatively finalized measurement data immediately before the operation button 140 (the data finalizing button 140C) is detected to have been pressed may be extracted as the finalized data. This may be, for example, tentatively finalized data that goes back several pieces in time from the most recent piece in the tentatively finalized measurement data buffered in the memory unit 173. This can be said to be the data closest to the timing when the user attempted to acquire the measurement data in the tentatively finalized measurement data acquired without the influence of finger contact.

In this case, the number of pieces to go back from the most recent piece in time may be a predetermined number, or a predetermined time (tens of milliseconds).

Alternatively, the finalized data may be the oldest piece in time in the tentatively finalized measurement data buffered in the memory unit 173. In other words, the tentatively finalized measurement data sampled at time t31 in FIG. 11 may be extracted as the finalized data. It can be said that the data acquired at this timing is not affected by the contact between the finger and the indicator 100, and is also in accordance with the user's intention, since it is acquired at the timing when the user has brought the finger very close to the data finalizing button 140C in order to acquire the measurement value.

Alternatively, the finalized data may be the middle piece in time in the tentatively finalized measurement data buffered in the memory unit 173.

Alternatively, as shown in FIG. 11, an extreme approach determination threshold (this may be referred to as a second approach determination threshold) may be provided to detect the timing immediately before the finger touches the operation button 140. The extreme approach determination threshold may be set to 90% or 95% of the maximum sensor output value of the proximity sensor 150.

The measurement data finalized in this manner is displayed on the display unit 130, recorded (stored) as finalized data in the memory unit 173, or output to external devices (ST175).

Although it is necessary to limit the number of pieces of finalized data to be displayed on the display unit 130 to one piece, it is also possible to record (store) or output some pieces or all pieces of the sampled tentatively finalized measurement data as finalized data without limiting the number of pieces of finalized data to be recorded (stored) or output to one piece.

In the operation procedure for the measurement data finalization in FIG. 8, ST171 to ST173 may be eliminated, and when the data finalizing button 140C is detected to have been pressed (ST170: YES), the finalized data may be immediately extracted from the tentatively finalized measurement data (ST174).

However, considering that the user operation is confirmed when the user's finger is separated away from the operation button 140 (in this case, the data finalizing button 140C), it is desirable to confirm the button operation when the finger is farther away than the separation determination threshold. It is also desirable to confirm whether there is vibration (ST173) and to provide the finalized data to the user when the vibration has subsided. If the vibration does not fall within a predetermined threshold, or if there is some other disturbance, the measurement data may be flagged as a reference value.

The present invention is not limited to the above exemplary embodiments, and can be appropriately modified without departing from the gist.

As the measuring device, the present invention is not limited to small-sized contact measuring devices, but can also be applied to, for example, non-contact distance meters (range meters).

These include laser distance sensors (laser range meters), capacitive displacement sensors, and focal (confocal and chromatic) distance sensors. Like indicators (dial gauges), they are common in that they are measuring devices (detectors) having a single measurement axis perpendicular to the surface of an object to be measured.

The present invention can be effective for any measuring device in which the setting of the relative posture between a workpiece and the measuring device affects the accuracy of measurement although the measuring axis is not perpendicular to the workpiece.

As small-sized contact measuring devices, calipers and micrometers (micrometer heads) may be equipped with the functions of the present invention.

The use of the inertial sensor 160 is supplementally described.

The indicator 100 (dial gauge) includes a spring inside the measuring device main body 110, and the spring biases the spindle 120 in one direction (in the direction of exposure from the measuring device main body 110). The spring generates a proper measuring pressure, but after repeated use of the indicator 100 (dial gauge), the spring deteriorates. However, ordinary users often continue to use the indicator 100 without noticing the deterioration of the spring.

Therefore, inertial sensor 160 is used to evaluate the deterioration of the spring.

For example, the spindle 120 is brought to the most backward position (pushed into the measuring device main body 110) to move the spindle 120 forward the farthest by the biasing force of the spring. By evaluating the time it takes for the spindle 120 to move and the magnitude of the vibration when the spindle 120 is moved forward the farthest, the degree of deterioration of the internal mechanism of the indicator 100 (dial gauge) (in this case, the spindle biasing spring) can be evaluated. If the spring deteriorates, it takes longer for the spindle 120 to move. In addition, if the spring deteriorates, the spring cannot hold the spindle 120 firmly when the spindle 120 bounces back significantly after the farthest forward movement, which causes more vibration and a longer time for the vibration to subside.

As to implementations containing the above embodiments, following supplements are further disclosed.

### (Supplementary Note 1)

A measuring device according to an exemplary embodiment of the present invention includes:
a main body;
a position detector provided on the main body and configured to detect a position of an object to be measured by contact or non-contact;
an operation reception unit provided on the main body and configured to receive a command/operation from a user;
a proximity sensor configured to measure a distance between an object and the operation reception unit when the object approaches or moves away from the operation reception unit; and
a central control unit configured to control an overall operation.

### (Supplementary Note 2)

In an exemplary embodiment of the present invention, it is preferable that the operation reception unit is configured to receive a measurement data finalization command to finalize measurement data,
the central control unit is configured to sequentially store measurement values from the position detector in a memory unit as tentatively finalized measurement data when the proximity sensor detects that the object has approached the operation reception unit, and
the central control unit is configured to determine one or two or more pieces in the tentatively finalized measurement data stored in the memory unit as finalized measurement data when the operation reception unit receives the measurement data finalization command.

### (Supplementary Note 3)

In an exemplary embodiment of the present invention, it is preferable that, when the operation reception unit receives the measurement data finalization command, the central control unit is configured to determine, in the tentatively finalized measurement data stored in the memory unit, tentatively finalized measurement data immediately before the operation reception unit detects the measurement data finalization command as finalized measurement data.

### (Supplementary Note 4)

In an exemplary embodiment of the present invention, it is preferable that the operation reception unit is configured to receive a base point setting command, and when the operation reception unit receives the base point setting command and the proximity sensor subsequently detects that the object has moved away from the operation reception unit, the central control unit is configured to set the position of the object to be measured detected by the position detector as a base point.

### (Supplementary Note 5)

In an exemplary embodiment of the present invention, it is preferable that the operation reception unit receives a mode switch command to a hold mode, and
when the operation reception unit receives the mode switch command to the hold mode and the proximity sensor subsequently detects that the object has moved away from the operation reception unit, the central control unit is configured to start sampling measurement values from the position detector and to execute the commanded hold mode.

### (Supplementary Note 6)

In an exemplary embodiment of the present invention, it is preferable that the measuring device further includes an inertial sensor.

### (Supplementary Note 7)

In an exemplary embodiment of the present invention, it is preferable that the operation reception unit is configured to receive a command/operation from the user by being in contact with the object or by being pressed by the object.

### (Supplementary Note 8)

In an exemplary embodiment of the present invention, it is preferable that the position detector is a detector having a uniaxial measurement axis.

### (Supplementary Note 9)

In an exemplary embodiment of the present invention, it is preferable that the position detector includes:
a movable member provided on the main body to be movable forward and backward and to be brought into contact with the object to be measured; and
an encoder configured to detect a position of the movable member.

### (Supplementary Note 10)

In an exemplary embodiment of the present invention, it is preferable that the measuring device is a portable measuring device to be carried in a hand of the user, and
the measuring device is configured to be attached to a stand so as to maintain a relative posture or a relative position with respect to the object to be measured.

### (Supplementary Note 11)

A control method of a measuring device according to an exemplary embodiment of the present invention, the measuring device including a position detector provided on a main body and configured to detect a position of an object to be measured by contact or non-contact, an operation reception unit provided on the main body and configured to receive an command/operation from a user, a proximity sensor configured to measure a distance between an object and the operation reception unit when the object approaches or moves away from the operation reception unit, and a central control unit configured to control an overall operation, the control method includes:
sequentially storing, by the central control unit, measurement values from the position detector in a memory unit as tentatively finalized measurement data when the proximity sensor detects that the object has approached the operation reception unit; and
determining, by the central control unit, one or two or more pieces in the tentatively finalized measurement data stored in the memory unit as finalized measurement data when the operation reception unit receives a measurement data finalization command.

### (Supplementary Note 12)

The measuring device may include a computer (a CPU, a memory) to install a measuring device control program in the computer, and the measuring device control program may cause the computer to perform operations of the measuring device control method.

The measuring device control program may be distributed as recorded on a nonvolatile recording medium or may be downloaded via an Internet line or the like.
100 Indicator
110 Measuring device main body
120 Spindle
171 Encoder
130 Display unit
140 Operation reception unit
140 Operation button
140A Base point setting button
140B Hold mode switching button
140C Data finalizing button
150 Proximity sensor
160 Inertial sensor
170 Electric circuit
172 Central control unit
173 Memory unit
174 Transmitting/receiving unit

1. A measuring device comprising:
a main body;
a position detector provided on the main body and configured to detect a position of an object to be measured by contact or non-contact;
an operation reception unit provided on the main body and configured to receive a command/operation from a user;
a proximity sensor configured to measure a distance between an object and the operation reception unit when the object approaches or moves away from the operation reception unit; and
a central control unit configured to control an overall operation.

2. The measuring device according to claim 1, wherein
the operation reception unit is configured to receive a measurement data finalization command to finalize measurement data,
the central control unit is configured to sequentially store measurement values from the position detector in a memory unit as tentatively finalized measurement data when the proximity sensor detects that the object has approached the operation reception unit, and
the central control unit is configured to determine one or two or more pieces in the tentatively finalized measurement data stored in the memory unit as finalized measurement data when the operation reception unit receives the measurement data finalization command.

3. The measuring device according to claim 2, wherein
when the operation reception unit receives the measurement data finalization command, the central control unit is configured to determine, in the tentatively finalized measurement data stored in the memory unit, tentatively finalized measurement data immediately before the operation reception unit receives the measurement data finalization command as finalized measurement data.

4. The measuring device according to claim 1, wherein
the operation reception unit is configured to receive a base point setting command, and
when the operation reception unit receives the base point setting command and the proximity sensor subsequently detects that the object has moved away from the operation reception unit, the central control unit is configured to set the position of the object to be measured detected by the position detector as a base point.

5. The measuring device according to claim 1, wherein
the operation reception unit receives a mode switch command to a hold mode, and
when the operation reception unit receives the mode switch command to the hold mode and the proximity sensor subsequently detects that the object has moved away from the operation reception unit, the central control unit is configured to start sampling measurement values from the position detector and to execute the commanded hold mode.

6. The measuring device according to claim 1, further comprising an inertial sensor.

7. The measuring device according to claim 1, wherein the operation reception unit is configured to receive a command/operation from the user by being in contact with the object or by being pressed by the object.

8. The measuring device according to claim 1, wherein the position detector is a detector having a uniaxial measurement axis.

9. The measuring device according to claim 1, wherein
the position detector includes:
a movable member provided on the main body to be movable forward and backward and to be brought into contact with the object to be measured; and
an encoder configured to detect a position of the movable member.

10. The measuring device according to claim 1, wherein
the measuring device is a portable measuring device to be carried in a hand of the user, and
the measuring device is configured to be attached to a stand so as to maintain a relative posture or a relative position with respect to the object to be measured.

11. A control method for a measuring device including a position detector provided on a main body and configured to detect a position of an object to be measured by contact or non-contact, an operation reception unit provided on the main body and configured to receive an command/operation from a user, a proximity sensor configured to measure a distance between an object and the operation reception unit when the object approaches or moves away from the operation reception unit, and a central control unit configured to control an overall operation, the control method comprising:
sequentially storing, by the central control unit, measurement values from the position detector in a memory unit as tentatively finalized measurement data when the proximity sensor detects that the object has approached the operation reception unit; and
determining, by the central control unit, one or two or more pieces in the tentatively finalized measurement data stored in the memory unit as finalized measurement data when the operation reception unit receives a measurement data finalization command.
